(19) United States
(12) Patent Application Publication
(10) Pub. No.: US 2017/0307146 A1
(43) Pub. Date: Oct. 26, 2017

(54) LIGHTING DEVICE

(71) Applicant: GE Lighting Solutions, LLC, East Cleveland, OH (US)

(72) Inventors: Wei WANG, Xian (CN); Meixiu ZHU, Xian (CN); Chenguang ZHANG, Xian (CN)

(21) Appl. No.: 15/493,873

(22) Filed: Apr. 21, 2017

(30) Foreign Application Priority Data
Apr. 22, 2016 (CN) 201610255262.1

(51) Int. Cl. F21K 9/275; F21V 3/02; F21V 29/70; F21K 9/272; F21V 29/89; F21V 17/10; F21K 9/68; F21Y 2115/10

(52) U.S. Cl. CPC F21K 9/275; F21V 17/101; F21V 3/02; F21K 9/68; F21V 29/70; F21K 9/272; F21V 29/89; F21Y 2115/10

(57) ABSTRACT

This invention disclosed a lamp tube comprising a tube body, a light emitting member, and a support member. The support member has a support portion and an expansion portion. The support portion is located inside the tube body; the light emitting member is located on the support portion of the support member; the expansion portion of the support member extends from one side of the support portion of the support member, with the light emitting member installed to the inner wall of the tube body. At least part of the light from the light emitting member is emitted outside the tube body along the expansion portion. A lamp tube according to embodiments of the present invention is inexpensive, has a simple manufacturing process, and the light source can be emitted in a smaller angle, improving the concentration of light.

### TECHNICAL FIELD

The present invention relates to an illumination device, more particularly a lamp tube in an illumination device.

### BACKGROUND ART

LED (Light Emitting Diode) lamp tubes are also called light tubes, with the light source using LED as the illuminator. Existing LED lamp tubes mainly consist of light diffusing masks, substrate, power drivers and light emitting diodes. The substrate is mounted on the bottom inside the lamp tube, the light emitting diode is mounted on the substrate, and the light from the light emitting diode is transmitted from the lamp tube, thereby realizing illumination.

Typically, existing lamp tubes glue the substrate directly to the bottom inside the glass lamp tube, so the light emitting diode is close to the bottom of the lamp tube. Not only can traces of the adhesive be seen from the side or the back of this type of lamp tube, making it unsightly, the light emitted by the light emitting diode is scattered everywhere with a large emitting angle, so the light beam is not concentrated.

With the prices of the LED lamp tubes getting lower and lower, some venues want the light emitted from the LED lamp tube not to be scattered, but to have a smaller emitting angle and a more concentrated illumination.

Therefore, it is necessary to provide an improved solution to solve at least one of the problems described above.

### SUMMARY

An objective of embodiments of the present invention is to provide a lamp tube with a smaller light emitting angle.

A lamp tube according to embodiments of the present invention comprises: a tube body; a support member, located inside the tube body, consisting of a support portion and an expansion portion; and a light emitting member, located on the support portion of the support member; wherein, the expansion portion of the support member extends from one side of the support portion of the support member with the light emitting member installed to the inner wall of the tube body. At least part of the light emitted from the light emitting member is emitted outside the tube body along the expansion portion.

Optionally, the support member is at least partially a non-diffuse or a diffuse reflector.

Optionally, the angle formed between the support portion and the expansion portion of the support member is an obtuse angle.

Optionally, the support portion of the support member is configured to be planar or curved.

Optionally, the support member comprises a heat dissipation material. The support member can not only play a role in supporting the light emitting member and forming a smaller diffusion angle, but it can also act as a heat sink for the lamp tube, thus simplifying the modular production of the lamp tube parts.

Optionally, the lamp tube also comprises a stabilizing portion located between the inner wall of the tube body and the support member. The stabilizing portion further provides support for the support member.

Optionally, the lamp tube also comprises an end cap, with which the support member is secured inside the tube body.

Optionally, an engaging portion used to secure the support member inside the tube body is installed on the end cap.

Optionally, the engaging portion is configured as a U-shaped groove, the edges of the support portion and/or expansion portion of the support member are engaged inside the U-shaped engaging portion.

Optionally, the engaging portion is configured as a hook. The support member also comprises a stopper portion that mates with the hook to connect the engaging portion to the support portion.

As can be seen from the above summary of the technical solution of embodiments of the present invention, the light emitting member of the lamp tube is located on the support portion of the support member. The support member consists of a support portion and an expansion portion extending from the support portion to the inner wall of the tube body. Part of the light emitting from the light emitting member can be emitted along the expansion portion, thereby allowing the lamp tube to realize a smaller light emitting angle through the expansion portion of the support member. Compared with designs in which the light emitting member is directly located inside, the lamp tube in embodiments of the present invention can achieve a smaller light emitting angle, improving the illumination concentration.

In addition, compared with existing designs in which the light source of the lamp tube directly passes through the adhesive secured on the inner wall of the tube body, traces of the adhesive on embodiments of the present invention cannot be seen from the side or the back, thereby making it more visually pleasing. In regards to its production and installation, the process is simpler and provides a higher yield of qualifying products.

### BRIEF DESCRIPTION OF THE DRAWINGS

These and other features, aspects, and advantages of the present invention will become better understood when the following detailed description is read with reference to the accompanying drawings in which numerals are used to refer to the representative parts:

FIG. 1 is a schematic view of the lamp tube according to a first embodiment of the present invention;

FIG. 2 is a complimentary view of the tube body of the lamp tube shown in FIG. 1 and the end cap of a particular embodiment;

FIG. 3 is a cross-sectional view of the end cap of FIG. 2;

FIG. 4 is a cross-sectional view of the end cap of another embodiment;

FIG. 5 is a schematic view of the lamp tube according to a second embodiment of the present invention;

FIG. 6 is a schematic view of the lamp tube according to a third embodiment of the present invention;

FIG. 7 is a schematic view of the lamp tube according to a fourth embodiment of the present invention; and

FIG. 8 is a schematic view of the lamp tube according to a fifth embodiment of the present invention.

### DETAILED DESCRIPTION

The embodiments of the present invention will be described in detail below with reference to the accompanying drawings in order to assist those skilled in the art in the understanding of the subject matter claimed. In the following detailed description of these embodiments, the present specification does not describe in detail any of the known functions or configurations to avoid unnecessary details that affect the disclosure of embodiments of the present invention.

Unless otherwise defined, the technical and scientific terms used in the claims and the specification are as they are usually understood by those skilled in the art to which the present invention pertains. “First”, “second” and similar words used in this specification and in the claims do not denote any order, quantity or importance, but are merely intended to distinguish between different constituents. The terms “one”, “a” and the like are not meant to be limiting, but rather denote the presence of at least one. “Comprising”, “consisting” and similar words mean that elements or articles appearing before “comprising” or “consisting” include the elements or articles and their equivalent elements appearing behind “comprising” or “consisting”, not excluding any other elements or articles. “Connected”, “coupled” and similar words are not restricted to physical or mechanical connections, but may include electrical connections, whether direct or indirect.

The term “non-diffuse reflector” as used herein refers to a reflector that, when observing its reflection plane, the outline of its light source can be distinguished, with the reflected images appearing as the reflected object with different surface brightness when observed from different angles; “diffuse reflector” refers to a reflector that, when observing its reflection plane, the light source cannot be observed, with the reflective surface brightness basically the same when observing from different angles.

The term “light emitting angle” (or “light exiting angle”) used herein refers to the angle at which light emitted from the tube body of the lamp tube can reach.

For straight glass tube lamps, during actual use of the lamp tube, the wider the light emitting angle does not make it better; a traditional fluorescent tube has no directionality, with its light emitting angle as wide as 360 degrees. However, in fact, for lamp tubes with a light emitting angle of 360 degrees, only half is effective light that is usable. A lamp tube with a wider light emitting angle ensures that the target area has a larger illumination range; a lamp tube with a narrower light emitting angle can maximize the use of effective light to ensure the concentration of light on the target area. According to the above description, embodiments of the present invention provides a lamp tube.

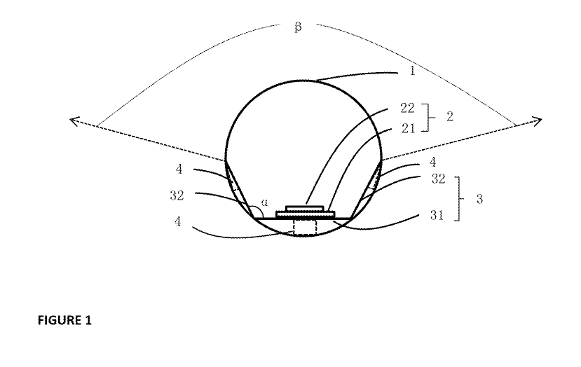

FIG. 1 shows a schematic view of a lamp tube according to a first embodiment of the present invention. As shown in FIG. 1, in the present embodiment, the lamp tube comprises a tube body 1, light emitting member 2 and support member 3, wherein the support member 3 is provided with a support portion 31 and expansion portion 32, the light emitting member 2 is located on the support portion 31 of the support member 3. The expansion portion 32 of the support member 3 extends from one side of the support portion 31 of the support member 3, with the light emitting member 2 installed, to the inner wall of the tube body 1, at least part of the light emitted from the light emitting member 2 is emitted outside the tube body 1 along the expansion portion 32.

Optionally, the light emitting member 2 comprises a PCB substrate 21 and an LED 22 configured on top of the substrate.

Optionally, a light-diffusing material is applied to the inside of the tube body 1 of the lamp tube, the light emitted by light emitting member 2 is evenly mixed through the reflection from the light-diffusing material inside tube body 1, thereby allowing better uniformity of the light emitted by the lamp tube.

Continuing with FIG. 1, in the present embodiment, the support member 3 is at least partially a non-diffuse reflector or a diffuse reflector. The angle formed between the support portion 31 and the expansion portion 32 of the support member 3 is α, where 90°≦α<180°. As shown in FIG. 1, in the present embodiment, the partial light emitted from the light emitting member 2 is reflected by the expansion portion 32 and/or the support portion 31, the light emitting angle β of the lamp tube is less than 200 degrees. When α gradually increases from 90°, the light emitting angle β of the lamp tube also increases. In general, in the existing designs, the light emitting element of the lamp tube is directly secured to the inner wall of the tube body through the use of an adhesive, that is, the light emitting member and the inner wall of the tube body are too close to each other, and the light emitting angle β is able to exceed 200°. In addition, traces of the adhesive can be seen on the side or back of the lamp tube, making it unsightly. In the present embodiment, in order to realize a narrower light emitting angle, the light emitting element 2 is provided on the support portion 31 of the support member 3. At least part of the light emitted from the light emitting member 2 is emitted outside the tube body 1 along the expansion portion 32. Compared with existing technology in which the light emitting member is directly located inside the lamp tube, the lamp tube of embodiments of the present invention can achieve a smaller light emitting angle that improves the illumination concentration of the lamp tube.

Optionally, the support portion 31 of the support member 3 can be a planar, a curved surface or other shapes capable of supporting the light emitting member.

The support member 3 comprises a heat dissipation material which can dissipate the heat of the lamp. In order to facilitate the manufacturing and installation of the lamp tube, support member 3 is usually formed integrally with aluminum foil. Optionally, it may also be made of other materials with heat dissipation properties, such as metals. In addition, the support member 3 may also be made of other non-heat-dissipating materials such as plastic, resin, etc. It is possible to provide a heat dissipation coating or a heat dissipation film on the support member 3 made of a non-heat-dissipating material in order to achieve heat dissipation for the lamp tube according to actual needs.

Referring again to FIG. 1, in the present embodiment, a stabilizing portion 4 to provide further support to the support member 3 is provided between the inner wall of the tube body 1 and the support member 3. The stabilizing portion 4 may be provided between the support portion 31 of the support member 3 and the inner wall of the tube body 1, or it may be provided between the expansion portion 32 of the support member 3 and the inner wall of the tube body 1. The stabilizing portion 4 may also be integral with the support member 3, or it may be a separate member.

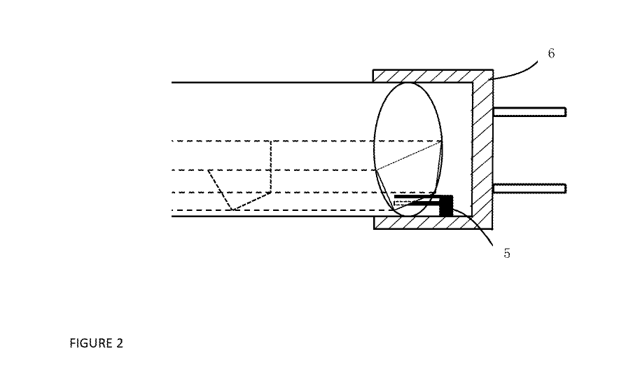

As shown in FIG. 2, the lamp tube of embodiments of the present invention may further comprise an end cap 6, whereby it is fixed by the support member 3 through the end cap 6 inside the tube body 1. In the present embodiment, the end cap 6 is provided with one or more engaging portions 5, and the support member 3 is fixed inside the tube body 1 by one or more engaging portions 5.

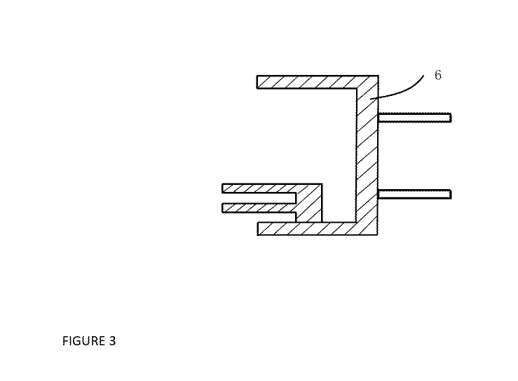

As shown in FIG. 3, in one embodiment, the engaging portion 5 may be configured as a U-shaped groove. The edges of the support portion 31 and/or expansion portion 32 of the support member 3 are engaged inside the U-shaped engaging portion 5, thereby, connecting the support member 3 to inside the tube body 1 through the U-shaped engaging portion 5 of the end cap 6. Furthermore, the inner edge of the end cap 6 can be securely connected to the outer edge of the tube body 1 using an adhesive, so that the support member 3 is even more securely fixed within the tube body 1.

Although the engaging portion 5 disclosed in the present embodiment is U-shaped, it is to be understood that the U-shaped engaging portion 5 may also be configured as other similar shapes capable of functioning similarly.

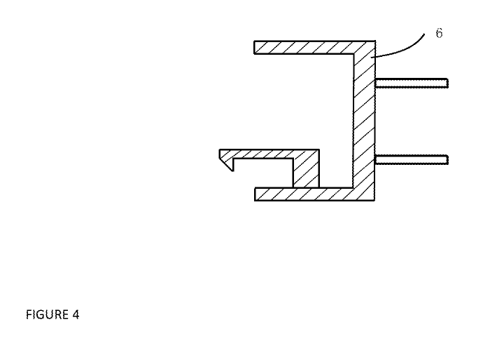

As shown in FIG. 4, in another embodiment, the engaging portion 5 may also be configured as a hook, wherein the support member 3 may also work together with the hook to connect the engaging portion 5 to the stopper portion of the support member 3 (not shown in the figure). The stopper portion may be provided on the support portion 31 and/or the expansion portion 32 of the support member 3. The hook is connected to the stopper portion to secure support member 3. In particular, the hook and the stopper portion are engaged with each other so as to secure the support member 3 inside the tube body 1. The stopper portion can be constructed in a variety of forms, such as projections, recesses or small holes.

In order to facilitate the securing, mounting and manufacturing of the support member 3, in the present embodiment, the support member 3 can be directly placed inside the tube body 1, where the support member 3 and the inner wall of the tube body are in linear contact. Optionally, the support member may also be secured within the tube body by means of an adhesive, when not considering aesthetics or when there are other means to apply the adhesive without it being observable from the outside of the lamp tube.

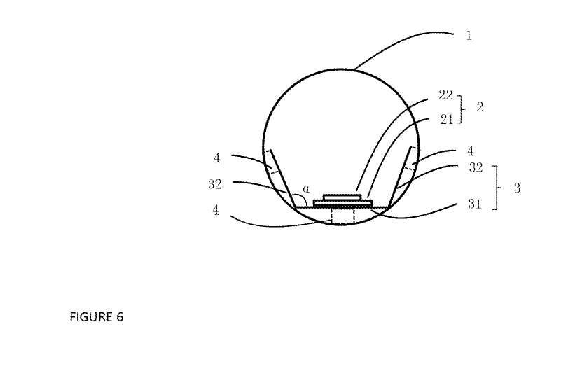

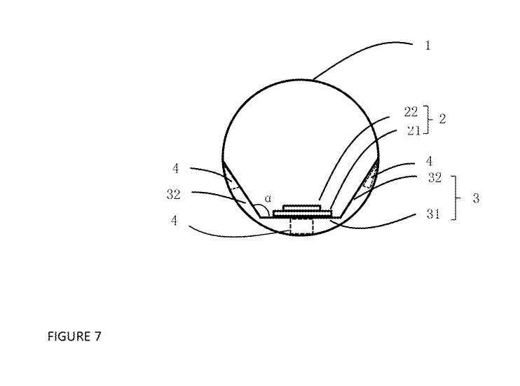

Referring again to FIG. 1, both ends of the expansion portion 32 of the support member 3 may both be in contact with the inner wall of the tube body 1, i.e. support member 3 and tube body 1 are in linear contact. Optionally, as shown in FIGS. 6 and 7, the expansion portion 32 of the support member 3 may also have only one end in contact with the inner wall of the tube body 1, that is, the support portion 31 of the support member 3 and the inner wall of tube body 1 are in linear contact. Optionally, the support member 3 may not be in contact with the inner wall of the tube body 1, but may be fixed in the tube body 1 by an end cap, or may be fixed inside the tube body 1 by an adhesive.

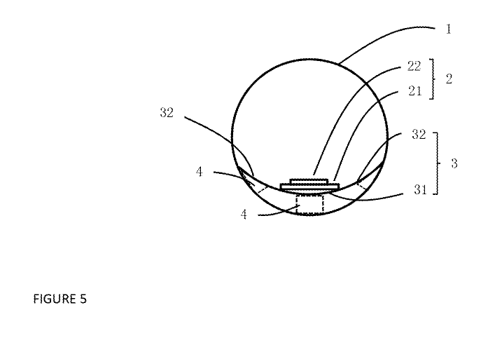

FIG. 5 is a schematic view of an exemplary lamp tube according to a second embodiment of the present invention. The lamp tube of the second embodiment shown in FIG. 5 is similar to the first embodiment as shown in FIG. 1, in principle and structure. The difference is that in the second embodiment, the support member 3 has a curved cross section, with the support portion 31 and the expansion portion 32 of the support member 3 the curved bottom portion and a segment of both sides, respectively. In order to facilitate the securing, mounting and manufacturing of the support member 3, in the present embodiment, the support member 3 can be directly placed inside the tube body 1, and the support member 3 and the inner wall of the tube body are in linear contact. Optionally, support member 3 may also be secured within the tube body 1 by an adhesive.

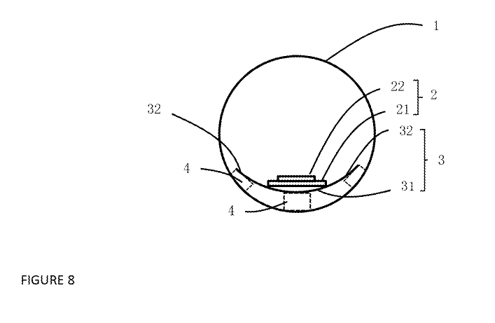

As shown in FIG. 5, one end of the expansion portion 32 of the support member 3 and the inner wall of tube body 1 are in linear contact. Optionally, as shown in FIG. 8, the support member 3 may not be in contact with the inner wall of the tube body 1, but is fixed to the tube body 1 only by the end cap 6 or fixed to inside the tube body 1 by an adhesive.

Although the cross-sectional shape of the support member 3 disclosed in the embodiments of the present invention may be trapezoidal or curved, it should be understood that shapes similar to the cross section of support member 3 may also comprise a concave structure and other shapes, in addition to the two mentioned above.

In the embodiment of the present invention, the support member 3 has an expansion portion 32 extending from one side of the support portion 31, with the light emitting member 2 installed to the inner wall of the tube body 1, and part of the light from the light emitting member 2 provided on the support member 3 emitted outside the lamp tube along the expansion portion 31. Therefore, the support member 3 not only supports the light emitting member 2, but it also acts as a light reflector and/or collimator. Since the lamp tube is provided with a support member 3 that comprises an expansion portion 32, it can thereby optimize light distribution and achieve control of the light emitting angle.

While the present invention has been described in detail with reference to specific embodiments thereof, it will be understood by those skilled in the art that many modifications and variations can be made in the present invention. It is, therefore, to be understood that the appended claims are intended to cover all such modifications and variations insofar as they are within the true spirit and scope of the invention.

What is claimed:

1. A lighting device, comprising:
a tubular member;
a support member arranged inside the tubular member, and comprising a support portion and an expansion portion;
light sources arranged on one side of the support portion of the support member;
wherein the expansion portion extends from the side of the support portion towards an inner wall of the tubular member, and at least some of the light emitted by the light source irradiates out of the tubular member along the expansion portion.

2. The lighting device according to claim 1, wherein at least a portion of the support member is reflective.

3. The lighting device according to claim 1, wherein an obtuse angle is formed by the support portion and the expansion portion.

4. The lighting device according to claim 1, wherein the support portion of the support member is configured to be planar or curved.

5. The lighting device according to claim 1, wherein the support member comprises a heat dissipation material.

6. The lighting device according to claim 1, further comprising a stabilizing portion for further support of the support member, wherein the stabilizing portion is arranged between the inner wall of the tubular member and the support member.

7. The lighting device according to claim 1, further comprising an end cap, wherein the support member is fixed inside the tubular member by the end cap.

8. The lighting device according to claim 7, wherein the end cap comprises an engaging portion for fixing the support member inside the tubular member.

9. The lighting device according to claim 8, wherein the engaging portion is configured to be a U-shaped groove, and the support portion and/or expansion portion is fixed in the U-shaped groove by adhesive.

10. The lighting device according to claim 8, wherein the engaging portion is configured to be a hook; the support member further comprises a block portion, and the hook is mated with the block portion to fix the support member onto the tubular member.
